(19) United States
(12) Patent Application Publication
(10) Pub. No.: US 2021/0324491 A1
(43) Pub. Date: Oct. 21, 2021

(54) ELECTRICAL STEEL SHEET WITH INSULATING FILM AND METHOD FOR MANUFACTURING THE SAME

(71) Applicant: JFE STEEL CORPORATION, Tokyo (JP)

(72) Inventors: Chiyoko TADA, Tokyo (JP); Nobuko NAKAGAWA, Tokyo (JP); Takashi WADA, Tokyo (JP); Shota TSUJI, Tokyo (JP); Naoki MURAMATSU, Tokyo (JP)

(73) Assignee: JFE STEEL CORPORATION, Tokyo (JP)

(21) Appl. No.: 17/273,179

(22) PCT Filed: Jul. 8, 2019
(86) PCT No.: PCT/JP2019/026919

§ 371 Date: Mar. 3, 2021

(30) Foreign Application Priority Data
Sep. 3, 2018 (JP) 2018-164344

(51) Int. Cl. C21D 9/46; C22C 38/06; B05D 1/02; B05D 3/02; B05D 1/28; C22C 38/02; C22C 38/04

(52) U.S. Cl. CPC C21D 9/46; C22C 38/06; B05D 1/02; B05D 3/0254; B05D 2301/00; C22C 38/02; C22C 38/04; B05D 2202/10; B05D 1/28

(57) ABSTRACT

An electrical steel sheet with an insulating film having excellent chromium elution resistance, even in the case where the insulating film is baked by utilizing rapid heating, which improves productivity, and a method for manufacturing the steel sheet. The insulating film contains Fe, Cr, an organic resin, and an organic reducing agent on at least one surface of an electrical steel sheet. A ratio of the Fe content to the Cr content (Fe/Cr) is 0.010 to 0.6 in terms of molar ratio in the insulating film.

### TECHNICAL FIELD

This application relates to an electrical steel sheet with an insulating film and a method for manufacturing the steel sheet.

### BACKGROUND

The insulating film of an electrical steel sheet which is used for a motor, a transformer, or the like is required to have not only interlayer resistance but also various properties. Examples of such properties include convenience in a forming process, corrosion resistance during storage, surface appearance stability, and stable insulation performance (interlayer resistance) in practical use. Moreover, since an electrical steel sheet is used in various applications, various insulating films have been developed in accordance with the intended applications. Such insulating films are classified broadly into 3 kinds: (1) semi-organic film, (2) inorganic film, and (3) organic film.

Usually, electrical steel sheets are punched, stacked in layers, and fixed to form an iron core for a motor or a transformer. To remove strain due to work, which is generated during fabrication processes in the electrical steel sheets, and to thereby improve magnetic properties, stress-relief annealing is performed at a temperature of 700° C. or higher in many cases. In the case of electrical steel sheets used in applications in which such stress-relief annealing is performed, since such steel sheets are required to have sufficient heat resistance to resist heat applied when stress-relief annealing is performed, (1) semi-organic film or (2) inorganic film described above is used. A major difference between the films of (1) and (2) is whether or not a resin is contained, and there is a difference in the balance of film properties depending on whether or not a resin is contained. Therefore, a selection between (1) and (2) is made on the basis of properties which are regarded as important.

When (1) semi-organic film and (2) inorganic film are formed, various base compounds such as chromate-based compounds, phosphate-based compounds, and inorganic colloid-based compounds, and, in particular, chromate-based compounds are widely used because chromate-based compounds are excellent in terms of various properties. However, in the case where chromate-based base compounds are used, since hexavalent chromium is highly harmful, hexavalent chromium is required to be reduced to trivalent chromium when the film is formed so that no hexavalent chromium is contained in a product. Therefore, baking conditions and baking temperatures are important control items when the film is formed.

Therefore, as examples of an electrical steel sheet which meets such requirements, electrical steel sheets with an insulating film in which chromic acid contains aluminum compounds while the contents of alkaline-earth metals are controlled to be certain amounts or lower are proposed (for example, Patent Literature 1 and Patent Literature 2). In the case of such electrical steel sheets with an insulating film, it is possible to decrease, even in the case where a chromate-based base compound is used, the baking temperature and to meet the requirement for rapid coating, which effectively contributes to improving productivity and saving energy.

### CITATION LIST

### Patent Literature

PTL 1: Japanese Unexamined Patent Application Publication No. 9-291368

PTL 2: Japanese Unexamined Patent Application Publication No. 11-92958

### SUMMARY

### Technical Problem

When an electrical steel sheet with an insulating film is manufactured, as examples of a method to increase the line speed and to thereby improve productivity, low-temperature baking and rapid coating are effective as described in Patent Literature 1 and Patent Literature 2. Examples of an effective method other than those described above include a method in which the heating rate is increased by utilizing rapid heating when baking is performed.

However, low-temperature baking or rapid coating is not originally a technique which is effective for improving chromium elution resistance. In addition, it may be said that the effect of improving productivity due to low-temperature baking or rapid coating is not sufficient. In the case where the insulating film is baked by utilizing rapid heating to improve productivity, since a reduction reaction of hexavalent chromium to trivalent chromium does not progress sufficiently, there may be a case where hexavalent chromium remains in a product, which results in a problem regarding chromium elution resistance when manufacturing is performed by utilizing rapid heating.

The disclosed embodiments have been completed to solve the problems described above, and an object of the disclosed embodiments is to provide an electrical steel sheet with an insulating film having excellent chromium elution resistance, even in the case where the insulating film is baked by utilizing rapid heating, which is advantageous for improving productivity, and to provide a method for manufacturing the steel sheet.

### Solution to Problem

To achieve the object described above, the present inventors diligently conducted investigations regarding an insulating film baked by utilizing rapid heating and, as a result, newly found that it is possible to obtain an electrical steel sheet with an insulating film having excellent chromium elution resistance in the case where the insulating film contains Fe, Cr, an organic resin, and an organic reducing agent and the ratio of the Fe content to the Cr content (Fe/Cr) is within a predetermined range.

In addition, it was found that it is possible to markedly improve chromium elution resistance by performing heating for baking from the underlayer of the insulating film, that is, from the side of the steel sheet, instead of performing baking from the side of the surface of the insulating film as in conventional cases where a gas furnace or an electric furnace is used.

The disclosed embodiments have been completed on the basis of the knowledge described above. That is, the subject matter of the disclosed embodiments is as follows.

[1] An electrical steel sheet with an insulating film, the steel sheet having an insulating film containing Fe, Cr, an organic resin, and an organic reducing agent on at least one surface of an electrical steel sheet, in which a ratio of the Fe content to the Cr content (Fe/Cr) is 0.010 to 0.6 in terms of molar ratio in the insulating film.

[2] The electrical steel sheet with an insulating film according to item [1], in which a particle diameter of the organic resin is 30 nm to 1000 nm.

[3] A method for manufacturing an electrical steel sheet with an insulating film, the method including applying a treatment solution containing a chromium compound having a trivalent chromium/total chromium mass ratio of 0.5 or less, an organic resin, and an organic reducing agent to at least one surface of an electrical steel sheet and heating the electrical steel sheet with the treatment solution from a side of the steel sheet at a heating rate of 20° C./s or higher in a temperature range of 100° C. to 350° C. to bake the treatment solution.

[4] A method for manufacturing an electrical steel sheet with an insulating film, the method including applying a treatment solution including a chromium compound having a trivalent chromium/total chromium mass ratio of 0.5 or less, an organic resin, and an organic reducing agent to at least one surface of an electrical steel sheet and heating the electrical steel sheet with the treatment solution from a side of the steel sheet at a heating rate of 20° C./s or higher in a temperature range of 100° C. to 350° C. to bake the treatment solution.

[5] The method for manufacturing an electrical steel sheet with an insulating film according to item [3] or [4], in which the heating rate is higher than 35° C./s.

### Advantageous Effects

According to the disclosed embodiments, it is possible to obtain an electrical steel sheet with an insulating film having excellent chromium elution resistance, even in the case where the insulating film is baked by utilizing rapid heating, which is advantageous for improving productivity.

### DETAILED DESCRIPTION

Hereafter, the disclosed embodiments will be specifically described.

Although there is no particular limitation on the electrical steel sheet, which is a material for the disclosed embodiments, it is preferable that the chemical composition of the steel sheet be appropriately controlled in accordance with required properties. For example, since increasing specific resistance is effective for improving iron loss, it is preferable that Si, Al, Mn, Cr, P, Ni, and the like, which are specific resistance-increasing elements, be added. The contents of these elements may be set in accordance with required magnetic properties.

In addition, there is no particular limitation on minor constituents, segregating elements such as Sb and Sn, and the like. However, since C and S are elements which are disadvantageous for weldability, and since it is preferable that the C content and the S content be as low as possible from the viewpoint of magnetic properties, it is preferable that the C content be 0.01 mass % or lower and that the S content be 0.01 mass % or lower.

In addition, there is no particular limitation on the method used for manufacturing the electrical steel sheet, and various conventionally known methods may be used. In addition, although there is no particular limitation on the surface roughness of the electrical steel sheet, it is preferable that the three-dimensional surface roughness SRa be 0.5 μm or less in the case where a lamination factor is regarded as important. Moreover, there is no particular limitation on the final thickness of the electrical steel sheet, and electrical steel sheets having various thicknesses may be used. Here, it is preferable that the final thickness of the electrical steel sheet be 0.8 mm or less from the viewpoint of magnetic properties.

The electrical steel sheet with an insulating film according to the disclosed embodiments is characterized by having an insulating film containing Fe, Cr, an organic resin, and an organic reducing agent on at least one surface of an electrical steel sheet, in which a ratio of the Fe content to the Cr content (Fe/Cr) is 0.010 to 0.6 in terms of molar ratio in the insulating film. Hereafter, the insulating film according to the disclosed embodiments will be described.

In the disclosed embodiments, the insulating film contains Fe. The insulating film containing Fe is formed by diffusing Fe from the electrical steel sheet to the insulating film when the insulating film is formed. It is possible to appropriately control the amount of Fe diffused by controlling the heating rate when baking is performed. In particular, it is possible to promote the diffusion of Fe by using an induction heating method when baking is performed. It is considered that, by supplying heat to the insulating film (treatment solution) from the side of the steel sheet by using an induction heating method, the diffused Fe reacts with chromium to effectively reduce hexavalent chromium.

In the disclosed embodiments, the insulating film contains Cr. The insulating film containing Cr is formed by baking a treatment solution containing a chromium compound when the insulating film is formed. A chromium compound having a trivalent chromium/total chromium mass ratio of 0.5 or less as described below is contained as the chromium compound in the treatment solution. As a result of hexavalent chromium contained in the treatment solution being reduced to trivalent chromium through a reduction reaction with an organic reducing agent when baking is performed, it is possible to improve the chromium elution resistance of the insulating film.

The disclosed embodiments are characterized in that the ratio of the Fe content to the Cr content (Fe/Cr) is 0.010 to 0.6 in terms of molar ratio in the insulating film. In the case where the ratio (Fe/Cr) is 0.010 to 0.6 in terms of molar ratio, there is an improvement in the film properties, in particular, chromium elution resistance and corrosion resistance, of an electrical steel sheet with an insulating film. Although the reason for this is not clear, it is considered that, as a result of Cr and Fe being bonded together via O, since Cr and Fe tightly adhere to each other, Cr elution is inhibited, and the insulating film is densified. It is preferable that the Fe/Cr ratio be 0.030 to 0.6.

Here, as described below, it is possible to control the ratio (Fe/Cr) by performing heating, when the treatment solution is baked, from the side of the steel sheet at a heating rate within a predetermined range in a predetermined temperature range to bake the treatment solution, and, in particular, it is possible to promote the diffusion of Fe by using an induction heating method.

In addition, it is possible to determine the ratio (Fe/Cr) by dissolving the film with a hot alkaline solution. In the case where the film is dissolved in a hot alkaline solution, it is possible to determine the contents of Fe and Cr by, for example, immersing the steel sheet with a film in a hot 20 mass % NaOH aqueous solution to dissolve the film and performing ICP analysis to determine the amounts of Fe and Cr in the solution.

In the disclosed embodiments, the insulating film contains an organic resin. There is no particular limitation on the kind of the organic resin, and various kinds of resins such as acrylic resins, epoxy resins, urethane resins, phenol resins, styrene resins, amide resins, imide resins, urea resins, vinyl acetate resins, alkyd resins, polyolefin resins, and polyester resins may be used. These resins may be used separately in the form of a single substance or may be used in combination with each other in the form of a copolymer or a mixture. Moreover, there is no particular limitation on the form of the resin as long as the resin is an aqueous resin, and various forms such as an emulsion resin, a dispersion resin, a suspension resin, and a powdered resin are acceptable. A water-soluble resin, for which a particle diameter is not defined, may also be used in combination with these resins, because this makes it possible to inhibit cracks from occurring in the film after baking.

It is preferable that the amount of the organic resin added be 0.05 to 0.4 in terms of mass ratio with respect to the total amount of chromium. In the case where the amount of the organic resin is less than 0.05, it is not possible to achieve sufficient punchability. On the other hand, in the case where the amount of the resin is more than 0.4, there is a deterioration in heat resistance.

Here, it is preferable that the particle diameter of the organic resin in the form of a solid be 30 nm or more. In the case where the particle diameter is small, since there is an increase in specific surface area, there is a deterioration in the stability of the treatment solution used for forming the insulating film. Although there is no particular limitation on the upper limit of the particle diameter, it is preferable that the particle diameter be 1 μm (1000 nm) or less in the case where it is considered important to increase the lamination factor of the electrical steel sheet in a motor or a transformer, which is a final product.

In the disclosed embodiments, the insulating film contains an organic reducing agent to promote the reduction reaction of chromium. Although there is no particular limitation on the kind of the organic reducing agent, it is preferable that a diol and/or at least a saccharide be used. In particular, it is more preferable that, among diols, ethylene glycol, propylene glycol, trimethylene glycol, or 1,4-butanediol be used and that, among saccharides, glycerin, polyethylene glycol, saccharose, lactose, sucrose, glucose, or fructose be used.

It is preferable that the amount of the organic reducing agent added be 0.1 to 2 in terms of mass ratio with respect to the total amount of chromium. This is because, in the case where the amount of the organic reducing agent is less than 0.1, a reduction reaction between chromic acid and the reducing agent does not progress sufficiently, and because, in the case where the amount of the organic reducing agent is more than 2, since the reaction becomes saturated, the reducing agent remains in the film, which results in a deterioration in weldability.

It is preferable that the insulating film according to the disclosed embodiments contain an additive as needed to further improve the quality and homogeneity of the film. As such an additive, a known additive which is used for a conventionally known chromate-based insulating film may be used. Examples of such an additive include organic or inorganic additives such as a surfactant (such as a non-ionic surfactant, a cationic surfactant, an anionic surfactant, a silicone-based surfactant, or acetylenediol), an anticorrosive (such as an amine-based anticorrosive or a non-amine-based anticorrosive), boric acid, a silane coupling agent (such as aminosilane or epoxysilane), a lubricant (such as wax), and an oxide sol (such as an alumina sol, a silica sol, an iron sol, a titania sol, a tin sol, a cerium sol, an antimony sol, a tungsten sol, or a molybdenum sol).

In the case where these additives are used, it is preferable, to maintain sufficient film properties, that the amount of the additives used be 10 mass % or less with respect to the total mass of the insulating film according to the disclosed embodiments in the form of a solid.

Hereafter, the method for manufacturing the electrical steel sheet with an insulating film according to the disclosed embodiments will be described.

In the disclosed embodiments, a treatment solution containing a chromium compound having a trivalent chromium/total chromium mass ratio of 0.5 or less, an organic resin, and an organic reducing agent is applied to at least one surface of an electrical steel sheet, and the electrical steel sheet with the treatment solution is heated from the side of the steel sheet at a heating rate of 20° C./s or higher in a temperature range of 100° C. to 350° C. to bake the treatment solution.

The treatment solution for the insulating film includes a chromium compound having a trivalent chromium/total chromium mass ratio of 0.5 or less, an organic resin, and an organic reducing agent. In the disclosed embodiments, it is necessary that the trivalent chromium/total chromium mass ratio be 0.5 or less. Hexavalent chromium contained in the chemical composition of the solution is reduced to trivalent chromium through a reduction reaction with the reducing agent when baking is performed and adsorbed onto the steel sheet. In the case where the trivalent chromium/total chromium mass ratio in the treatment solution is more than 0.5, there is a deterioration in the reactivity of hexavalent chromium when baking is performed due to the electric and steric effect of trivalent chromium which has been polymerized in the treatment solution, which results in a deterioration in the Cr elution resistance of the formed film. In addition, in the case where the trivalent chromium/total chromium mass ratio in the treatment solution is more than 0.5, gel sediments are generated due to trivalent chromium which has been polymerized in the treatment solution, which makes it difficult to maintain the quality of the treatment solution.

Here, the treatment solution according to the disclosed embodiments is an aqueous solution containing at least one of chromic anhydride, chromates, and dichromates as a base compound. Examples of the chromates and the dichromates include chromates and dichromates containing at least one selected from the metals such as Ca, Mg, Zn, K, Na, and Al.

In addition, the treatment solution according to the disclosed embodiments is a treatment solution including a chromium compound having a trivalent chromium/total chromium mass ratio of 0.5 or less, an organic resin, and an organic reducing agent, and the solution does not contain Fe (such as Fe ions or Fe compounds). When the treatment solution and the steel sheet come into contact with each other, the surface of the steel sheet is dissolved to generate Fe ions. It is preferable that Fe be mixed into the treatment solution when water, which is the solvent of the treatment solution, is vaporized to form a film in a baking process. In the disclosed embodiments, the reason why the Fe source is limited to the dissolution of the surface of the steel sheet is because there is an improvement in corrosion resistance and adhesiveness as a result of the polar groups (Cr—O— or Cr—OH—) of trivalent chromium, which has been polymerized in the treatment solution, tightly adhering to Fe, in a baking process, on the surface which has been newly formed due to dissolution.

There is no particular limitation on the method used for applying the treatment solution described above as long as it is possible to apply the treatment solution to the surface of the steel sheet, and various methods such as a roll coater method, a bar coater method, an air knife method, and a spray coater method may be used.

After the treatment solution has been applied, baking for forming the insulating film is performed in such a manner that heating is performed from the side of the steel sheet at a heating rate of 20° C./s or higher in a temperature range of 100° C. to 350° C. The reason why rapid heating is performed at a heating rate of 20° C./s or higher in the temperature range described above is because this promotes the dissolution of Fe from the steel sheet so that the ratio of the Fe content to the Cr content (Fe/Cr) in the insulating film is within a predetermined range. In the case where rapid heating is performed in a temperature range of lower than 100° C., local explosive boiling, for example, occurs in the water, which is the solvent of the treatment solution, and a film may be inhomogeneous.

Although the maximum end-point temperature in the process of baking the treatment solution may be set as needed so that it is possible to form a coating, the maximum end-point temperature is set to be 100° C. to 350° C., because an aqueous solution containing an organic resin is used as a treatment solution. In the case where the maximum end-point temperature is lower than 100° C., the water, which is the solvent, tends to remain. On the other hand, in the case where the maximum end-point temperature is higher than 350° C., there a risk of thermal decomposition of the organic resin starting. It is particularly preferable that the maximum end-point temperature be 150° C. to 350° C.

Therefore, in the disclosed embodiments, the heating rate in a temperature range of 100° C. to 350° C. is set to be 20° C./s or higher. It is preferable that the heating rate be higher than 35° C./s. Here, there is no particular limitation on the upper limit of the heating rate. However, in the case where the heating rate is excessively high, there is an increase in the size of a heating apparatus and in equipment costs, and thus it is preferable that the heating rate be 200° C./s or lower or more preferably 150° C./s or lower.

Regarding the method used for baking the treatment solution to form the insulating film, it is important that heating be performed from the side of the steel sheet. In the case of heating methods which are conventionally used in many cases and in which heating is performed from the side of the coating surface by using a gas furnace, an electric furnace, or the like, when the heating rate is excessively high, the outermost layer is dried early while low-boiling point substances (such as the solvent and reaction products) remain within the film, which results in poor surface appearance due to swelling or the like. In addition, since the organic reducing agent does not react sufficiently, the organic reducing agent is dissolved in a testing solution when an elution test is performed so that the organic reducing agent reduces hexavalent chromium, which has also been dissolved in the testing solution, which may make it difficult to accurately evaluate chromium elution resistance. In the case where heating is performed from the side of the steel sheet, since baking progresses from the underlayer of the coating, hexavalent chromium is effectively reduced, and there is no poor surface appearance, even in the case where baking is performed at an ultra-high heating rate of about 150° C./s.

It is not necessary that the method for performing heating from the side of the steel sheet be used throughout the baking process, and such a method may be used partially. In the case where the method for performing heating from the side of the steel sheet is used partially, it is preferable that such a method be used for 0.5 seconds or more in the baking process.

Here, the expression “heating from the side of the steel sheet” in the disclosed embodiments denotes a case where the steel sheet is heated from the inside thereof by generating heat inside the steel sheet, instead of heating the steel sheet from the outside of the steel sheet. Examples of such a heating method include an induction heating method in which eddy currents are generated inside a steel sheet by using magnetic force lines so that Joule heat is generated inside the steel sheet, and a direct energization heating method in which electric currents are directly passed through a steel sheet so that Joule heat is generated inside the steel sheet. However, on a practical manufacturing line, since it is difficult to perform a direct energization heating method in which electric currents are directly passed through a running steel sheet, an induction heating method in which eddy currents are generated inside a running steel sheet by using magnetic force lines generated by electric currents supplied from the outside, is preferable.

As described above, an induction heating method in which heating is performed by utilizing eddy currents generated inside a steel sheet due to magnetic force lines generated by electric currents supplied from the outside is particularly preferable as a method for performing heating from the side of the steel sheet. Here, there is no particular limitation on the frequency for induction heating, the heating rate, or other conditions and such factors may be appropriately set in accordance with, for example, the heating time and efficiency, which are constrained by equipment conditions, and the properties of the electrical steel sheet (such as thickness and magnetic permeability).

As described above, by performing heating from the side of the steel sheet, there is an improvement in chromium elution resistance compared with the case where heating is performed from the side of the coating surface.

Here, it is preferable that the coating weight of the insulating film be 0.05 g/m² to 7.0 g/m². In the case where the coating weight of the insulating film is less than 0.05 g/m², it is difficult to realize the homogeneity of the film, which results in unstable film properties. On the other hand, in the case where the coating weight of the insulating film is more than 7.0 g/m², there is a deterioration in film adhesiveness.

### EXAMPLES

Hereafter, the disclosed embodiments will be described in accordance with examples for better understanding of the disclosed embodiments. Here, the disclosed embodiments are not limited to the examples below.

By using a roll coater, each of the treatment solutions, which are aqueous solutions given in Table 1, was applied to an electrical steel sheet having a chemical composition containing C: 0.003 mass %, S: 0.003 mass %, Si: 0.25 mass %, Al: 0.25 mass %, Mn: 0.25 mass %, and a balance of Fe and inevitable impurities and a thickness of 0.5 mm. Here, all of the treatment solutions included a chromium compound, an organic resin, and an organic reducing agent, and none of the treatment solutions included Fe (such as Fe ions and Fe compounds). Subsequently, a baking treatment was performed with the heating rates and the maximum end-point temperatures given in Table 1.

In addition, a heating method used for the baking treatment was an induction heating method (A), an air-heating furnace method (C), or a combination of both (B). Here, in the case of the induction heating method, the frequency was 30 kHz, and the supplied electric current was varied to vary the heating rate. By performing heating in such a manner, the heating rate in a temperature range of 100° C. to 350° C. was varied as shown in Table 1.

Evaluations below were performed on the obtained electrical steel sheets with an insulating film.

<Chromium Elution Resistance>

Chromium elution resistance was evaluated in accordance with EPA3060A. An eluate was prepared by dissolving 20 g of Sodium Hydroxide and 30 g of Sodium Carbonate (both are Guaranteed Reagents produced by FUJIFILM Wako Pure Chemical Corporation) in pure water to obtain a solution having a constant volume of 1 liter. After 50 ml of this eluate had been put in a beaker and heated to a temperature of 90° C. to 95° C., the sample of the electrical steel sheet with an insulating film, 0.4 g of MgCl₂ (anhydrous), and 0.5 ml of a buffer solution (prepared by dissolving 87 g of K₂HPO₄ and 68 g of KH₂PO₄ in 1 liter of pure water) were added, stirring was thereafter performed for 5 minutes, and elution was then performed at a temperature of 90° C. to 95° C. for 60 minutes. Subsequently, after having filtered the eluate, HNO₃ of 5 mol/liter was added to the obtained filtrate to control the pH of the solution to be 7.5±0.5 to obtain a solution having a constant volume of 250 ml. After an aliquot of 95 ml had been taken, a 10% H₂SO₄ solution was added to control the pH of the solution to be 2.0±0.5, and 2 ml of a 0.5% diphenylcarbazide solution was then added to obtain a solution having a constant volume of 100 ml. After the obtained solution had been left to stand for 5 minutes to 10 minutes, the amount of Cr⁶⁺ was determined and converted into the amount of hexavalent chromium. Evaluation was performed on the basis of the following criteria, and a case of Δ or x was judged as unsatisfactory.

⊙: less than 0.2 mg/m²
◯: 0.2 mg/m² or more and less than 0.5 mg/m²
Δ: 0.5 mg/m² or more and less than 1.0 mg/m²
x: 1.0 mg/m² or more

<Boiling Steam Exposure Test>

The surface appearance of a sample was evaluated after the sample had been exposed to boiling steam for 30 minutes, and a case of Δ or x was judged as unsatisfactory.

⊙: without change
◯: almost without change
Δ: slight change (whitening, rusting, and the like)
x: significant change (whitening, rusting, and the like)

<Corrosion Resistance>

Corrosion resistance was evaluated by performing a salt spray test in accordance with JIS-Z2371 under the condition of a temperature of 35° C. in a 5% NaCl solution. A state in which rusting occurred was visually observed, and judgement was performed on the basis of the time taken for the rust area ratio to reach 5%. A case of Δ or x was judged as unsatisfactory.

⊙: 24 Hr or more
◯: 12 Hr or more and less than 24 Hr
Δ: 7 Hr or more and less than 12 Hr
x: less than 7 Hr

<Surface Appearance Evaluation Using SEM>

Ten fields of view on the surface of the insulating film were observed by using a SEM (scanning electron microscope) at a magnification of 1000 times to investigate cracks occurring in the insulating film. Evaluation was performed on the basis of the following criteria, and a case of Δ or x was judged as unsatisfactory.

⊙: total number of cracks identified in 10 fields of view was 0
◯: total number of cracks identified in 10 fields of view was 1 or more and less than 10
Δ: total number of cracks identified in 10 fields of view was 10 or more and less than 30
x: total number of cracks identified in 10 fields of view was 30 or more

<Lamination Factor>

Lamination factor was evaluated in accordance with JIS C 2550. Evaluation was performed on the basis of the following criteria, and a case of x was judged as unsatisfactory.

⊙: 99% or more
◯: 98% or more and less than 99%
Δ: 97% or more and less than 98%
x: less than 97%

The results are given in Table 1.

TABLE 1

| | Chemical Composition of Treatment Solution for Forming Insulating Film | | | | | | | | | | | | | | | |
|---|---|---|---|---|---|---|---|---|---|---|---|---|---|---|---|---|
| | Trivalent | | | | | Organic | | | | | | Evaluation Result | | | | |
| | Chromium/ | | Particle | Organic | | Reducing | | | 2) | Maximum | | | Boiling | | SEM | |
| | Total | | Diameter of | Resin/Total | | Agent/Total | Coating | 1) | Heating | End-point | Fe/Cr | Chromium | Steam | | Surface | Lamina- |
| | Chromium | | Organic | Chromium | Organic | Chromium | Weight | Heating | Rate | Temperature | Molar | Elution | Exposure | Corrosion | Appear- | tion |
| Item | Mass Ratio | Organic Resin | Resin (nm) | Mass Ratio | Reducing Agent | Mass Ratio | (g/m²) | Method | (° C./s) | (° C.) | Ratio | Resistance | Property | Resistance | ance | Factor |
| Example 1 | 0 | Acryl | 50 | 0.2 | Ethylene Glycol | 0.5 | 0.7 | A | 100 | 300 | 0.050 | ⊙ | ⊙ | ⊙ | ⊙ | ⊙ |
| Example 2 | 0.1 | Vinyl Acetate | 70 | 0.2 | Glucose | 0.5 | 0.7 | A | 100 | 300 | 0.050 | ⊙ | ⊙ | ⊙ | ⊙ | ⊙ |
| Example 3 | 0.3 | Urethane | 30 | 0.2 | Sucrose | 0.3 | 0.7 | A | 100 | 300 | 0.050 | ⊙ | ⊙ | ⊙ | ⊙ | ⊙ |
| Example 4 | 0.5 | Acryl/Urethane | 30 | 0.2 | Lactose | 0.3 | 0.7 | A | 100 | 300 | 0.050 | ⊙ | ⊙ | ⊙ | ⊙ | ⊙ |
| Example 5 | 0.1 | Acryl/Styrene | 100 | 0.2 | Ethylene Glycol | 2 | 3 | A | 100 | 300 | 0.010 | ◯ | ◯ | ◯ | ⊙ | ⊙ |
| Example 6 | 0 | Acryl | 80 | 0.2 | Sucrose | 0.5 | 0.5 | A | 100 | 300 | 0.300 | ⊙ | ⊙ | ⊙ | ⊙ | ⊙ |
| Example 7 | 0.5 | Acryl/Epoxy | 150 | 0.2 | Lactose | 0.5 | 0.2 | A | 100 | 300 | 0.500 | ⊙ | ⊙ | ⊙ | ⊙ | ◯ |
| Example 8 | 0.5 | Acryl/Epoxy | 150 | 0.2 | Ethylene Glycol | 0.5 | 0.1 | A | 100 | 300 | 0.600 | ⊙ | ⊙ | ⊙ | ⊙ | ◯ |
| Example 9 | 0 | Acryl/Styrene | 100 | 0.2 | Ethylene Glycol | 0.5 | 0.7 | B | 25 | 200 | 0.020 | ◯ | ◯ | ◯ | ⊙ | ⊙ |
| Example 10 | 0 | Acryl/Styrene | 100 | 0.2 | Ethylene Glycol | 0.5 | 0.7 | B | 60 | 200 | 0.050 | ⊙ | ⊙ | ⊙ | ⊙ | ⊙ |
| Example 11 | 0.3 | Vinyl Acetate | 70 | 0.2 | Glucose | 0.5 | 0.7 | A | 130 | 300 | 0.050 | ⊙ | ⊙ | ⊙ | ⊙ | ⊙ |
| Example 12 | 0.3 | Vinyl Acetate | 70 | 0.2 | Glucose | 0.1 | 0.7 | A | 100 | 300 | 0.050 | ◯ | ⊙ | ⊙ | ⊙ | ⊙ |
| Example 13 | 0.3 | Vinyl Acetate | 70 | 0.2 | Sucrose | 1 | 0.7 | A | 100 | 300 | 0.050 | ⊙ | ⊙ | ⊙ | ⊙ | ⊙ |
| Example 14 | 0 | Acryl | 50 | 0.2 | Ethylene Glycol | 0.5 | 0.7 | B | 60 | 300 | 0.040 | ⊙ | ⊙ | ⊙ | ⊙ | ⊙ |
| Example 15 | 0 | Acryl | 50 | 0.2 | Ethylene Glycol | 0.5 | 0.7 | B | 40 | 300 | 0.035 | ⊙ | ⊙ | ⊙ | ⊙ | ⊙ |
| Example 16 | 0 | Acryl | 50 | 0.2 | Ethylene Glycol | 0.5 | 0.7 | B | 25 | 300 | 0.012 | ◯ | ◯ | ◯ | ⊙ | ⊙ |
| Example 17 | 0 | Acryl | 100 | 0.2 | Ethylene Glycol | 0.5 | 0.7 | A | 100 | 300 | 0.050 | ⊙ | ⊙ | ⊙ | ⊙ | ⊙ |
| Example 18 | 0 | Acryl | 300 | 0.2 | Ethylene Glycol | 0.5 | 0.7 | A | 100 | 300 | 0.050 | ⊙ | ⊙ | ⊙ | ⊙ | ⊙ |
| Example 19 | 0 | Acryl | 1000 | 0.2 | Ethylene Glycol | 0.5 | 0.7 | A | 100 | 300 | 0.050 | ⊙ | ⊙ | ⊙ | ⊙ | ◯ |
| Example 20 | 0 | Acryl | 1500 | 0.2 | Ethylene Glycol | 0.5 | 0.7 | A | 100 | 300 | 0.050 | ⊙ | ⊙ | ⊙ | ⊙ | Δ |
| Comparative Example 1 | 0.6 | Acryl | 50 | 0.2 | Lactose | 0.5 | 0.7 | A | 100 | 300 | 0.009 | Δ | ⊙ | Δ | Δ | ⊙ |
| Comparative Example 2 | 0.3 | — | — | 0 | — | 0 | 0.7 | A | 100 | 300 | 0.004 | × | × | ⊙ | ⊙ | ⊙ |
| Comparative Example 3 | 0.3 | Acryl/Styrene | 100 | 0.2 | — | 0 | 0.7 | A | 100 | 300 | 0.004 | × | Δ | ⊙ | ⊙ | ⊙ |
| Comparative Example 4 | 0.3 | Acryl/Epoxy | 150 | 0.2 | Glucose | 0.5 | 0.7 | C | 15 | 300 | 0.002 | Δ | ⊙ | ⊙ | ⊙ | ◯ |
| Comparative Example 5 | 0.3 | Acryl/Epoxy | 150 | 0.2 | Ethylene Glycol | 0.5 | 0.7 | C | 15 | 200 | 0.002 | × | Δ | ⊙ | ⊙ | ◯ |
| Comparative Example 6 | 0 | Acryl | 50 | 0.2 | Ethylene Glycol | 0.5 | 0.7 | C | 15 | 300 | 0.008 | × | Δ | Δ | ⊙ | ⊙ |

1) heating method
A: induction heating
B: air-heating furnace + induction heating
C: air-heating furnace
2) heating rate in a temperature range of 100° C. to 350° C.

From the results given in Table 1, it was clarified that all of the examples of the disclosed embodiments were excellent in terms of film properties, and in particular, chromium elution resistance.

1. An electrical steel sheet comprising an insulating film disposed on at least one surface of the electrical steel sheet, the insulating film comprising Fe, Cr, an organic resin, and an organic reducing agent,
wherein a ratio of the Fe content to the Cr content (Fe/Cr) is in a range of 0.010 to 0.6 in terms of molar ratio in the insulating film.

2. The electrical steel sheet with an insulating film according to claim 1, wherein a particle diameter of the organic resin is in a range of 30 nm to 1000 nm.

3. A method for manufacturing an electrical steel sheet with an insulating film, the method comprising:
applying a treatment solution containing a chromium compound having a trivalent chromium to total chromium mass ratio of 0.5 or less, an organic resin, and an organic reducing agent to at least one surface of the electrical steel sheet; and
heating the electrical steel sheet with the treatment solution from a side of the steel sheet at a heating rate of 20° C./s or higher in a temperature range of 100° C. to 350° C. to bake the treatment solution.

4. A method for manufacturing an electrical steel sheet with an insulating film, the method comprising:
applying a treatment solution comprising a chromium compound having a trivalent chromium to total chromium mass ratio of 0.5 or less, an organic resin, and an organic reducing agent to at least one surface of the electrical steel sheet; and
heating the electrical steel sheet with the treatment solution from a side of the steel sheet at a heating rate of 20° C./s or higher in a temperature range of 100° C. to 350° C. to bake the treatment solution.

5. The method for manufacturing an electrical steel sheet with an insulating film according to claim 3, wherein the heating rate is higher than 35° C./s.

6. The method for manufacturing an electrical steel sheet with an insulating film according to claim 4, wherein the heating rate is higher than 35° C./s.
